(19) United States
(12) Patent Application Publication
(10) Pub. No.: US 2023/0157393 A1
(43) Pub. Date: May 25, 2023

(54) Garment With a Thermal Insulation Structure

(71) Applicant: adidas AG, Herzogenaurach (DE)

(72) Inventors: Barbara Ruth Hammer, Fuerth (DE); Jiabei Zhu, Erlangen (DE)

(21) Appl. No.: 17/990,072

(22) Filed: Nov. 18, 2022

(30) Foreign Application Priority Data
Nov. 20, 2021 (DE) 10 2021 005 754.6

(51) Int. Cl. A41D 31/06; A41D 1/02; A41D 1/04

(52) U.S. Cl. CPC A41D 31/065; A41D 1/02; A41D 1/04

(57) ABSTRACT

The invention relates to a garment with a thermal insulation structure. The thermal insulation structure comprises a first insulation element with a first insulation layer and a second insulation element with a second insulation layer, wherein the second insulation element has a different initial shape than the first insulation element and the first insulation element is connected to the second insulation element. The second insulation element is deformed when the garment is worn by a pressure on an inner side of the thermal insulation structure, so that a contact area, in which the first insulation element contacts the second insulation element, is increased. The thermal insulation structure further comprises a third insulation element with a third insulation layer.

### CROSS REFERENCE TO RELATED APPLICATION

This application claims priority to German application DE 10 2021 005 754.6, filed on Nov. 20, 2021, the entire contents and disclosures of which are incorporated herein.

### FIELD OF THE INVENTION

The present invention relates to a garment with a thermal insulation structure, wherein the garment is designed, in particular, for use in the outdoor sector.

### BACKGROUND

A main object of clothing, in particular in the outdoor sector, is to thermally insulate the body of a wearer of such a garment from the environment and to minimize a heat loss. For this purpose, a structure is typically selected in which a well-heat-insulating material is embedded between an outer layer and an inner layer in order thus to bring about the insulation effect. Both natural insulation materials, in particular down, and synthetic materials are used here.

In order to avoid undesired slipping or redistribution of the insulation material, the insulation material is in this case typically distributed over individual chambers or compartments, such as chamber construction known from DE102014200824 A1. Furthermore, a construction is known from the prior art in which the outer and inner layer of the garment are sewn or stitched directly to each other and, as a result, individual chambers are created which are filled with insulation material. However, the seam construction can allow heat to escape through the seam, or it can alternatively allow cold air to penetrate into the garment. Furthermore, however, it is a disadvantage of this construction that no insulation material is present in the region of the seams in which the outer layer and inner layer are directly in contact. As a result, a considerable heat loss takes place in the region of the seams. The heat loss via the seams may be reduced by the technical teaching published in DE102014200824 A1.

It is therefore an object of the present invention to provide a thermal insulation structure which further minimizes the heat loss.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

In some embodiments, the present disclosure is directed to a garment having a thermal insulation structure, the thermal insulation structure comprising: a first insulation element with a first insulation layer; and a second insulation element with a second insulation layer, wherein the second insulation element has a different initial shape than the first insulation element; the first insulation element is connected to the second insulation element, the second insulation element is deformed when the garment is worn by a pressure on an inner side of the thermal insulation structure, so that a contact area, in which the first insulation element contacts the second insulation element, is increased; characterized in that the thermal insulation structure further comprises a third insulation element with a third insulation layer. In some aspects, the first insulation element and the second insulation element are arranged one below the other when the garment is worn, and the third insulation element is arranged next to the first and the second insulation element when the garment is worn. The first insulation element and the second insulation element may be connected to each other by a seam, and the third insulation element may cover the seam between the first insulation element and the second insulation element.

In some aspects, the first insulation element may comprise a first inner fabric layer and a first outer fabric layer, wherein the first insulation layer is arranged between the first inner fabric layer and the first outer fabric layer, the second insulation element may comprise a second inner fabric layer and a second outer fabric layer, wherein the second insulation layer may be arranged between the second inner fabric layer and the second outer fabric layer, and the third insulation element may comprise a third inner fabric layer and a third outer fabric layer, wherein the third insulation layer may be arranged between the third inner fabric layer and the third outer fabric layer. In some aspects, the third insulation element may constitute an outermost insulation layer of the thermal insulation structure when the garment is worn.

In some embodiments, the first, the second and the third insulation element delimit a cavity between them, the cavity is filled with a heat-storing medium, and the heat-storing medium comprises air, down or a non-woven fabric. The first insulation layer, the second insulation layer, the third insulation layer, or combinations thereof may consist of real down, artificial down or of a non-woven fabric. The third insulation layer of the third insulation element may be a non-woven material. The third outer fabric layer of the third insulation element may be waterproof. The third insulation layer may be divided into several parts, wherein the parts of the insulation layer are arranged in chambers, wherein the chambers are formed by the third inner fabric layer and the third outer fabric layer of the third insulation element. The chambers may run in a vertical direction when the garment is worn. In some aspects, the first outer fabric layer of the first insulation element and the second outer fabric layer of the second insulation element and the third inner fabric layer of the third insulation element are connected to each other. In some aspects, the garment is a jacket, a vest, a coat or a pair of trousers. In some aspects, the garment comprises an inner part, wherein the inner part has the first insulation element and the second insulation element, the garment comprises an outer part, wherein the outer part has the third insulation element, air is enclosed in the cavity, which is formed between the first insulation element and the second insulation element of the inner part as well as the third insulation element of the outer part, and the inner part and the outer part are connected to each other by connecting elements. In some aspects, the garment is a jacket, a coat, or a vest, and wherein the connecting elements are arranged exclusively on the shoulder part and on the hip part of the garment.

### BRIEF DESCRIPTION OF THE DRAWINGS

In the following detailed description, embodiments of the invention are described referring to the following figures:

FIG. 1 shows an embodiment of a garment according to the invention as a jacket.

FIG. 2 shows an embodiment of a garment according to the invention as a vest.

FIG. 3 shows an embodiment of a garment according to the invention as a pair of trousers.

FIG. 4 shows a thermal insulation structure of a garment according to the invention according to FIG. 1, 2 or 3 in cross-section.

FIG. 5 shows a cocoon structure of a garment according to the invention with inner part and outer part.

### BRIEF DESCRIPTION

It is therefore an object of the present invention to provide a thermal insulation structure which further minimizes the heat loss. The object is achieved by the subject matter of claim 1. Advantageous embodiments are the subject matter of the subclaims, the figures and the following description.

The present invention provides a thermal insulation structure for a garment. The thermal insulation structure is distinguished in particular in that a heat loss in the region of possible seams is minimized or at least reduced. In one embodiment, the thermal insulation structure makes it possible here to enclose an additional air volume which fulfils the function of a thermal resistance toward the outside, in particular without interruptions arranged in between. In this sense, according to one aspect of the invention, a garment with a thermal insulation structure according to the invention is provided. The garment according to the invention may be designed here as a jacket or coat, as a vest or as trousers in each case of any desired shape. The thermal insulation structure has a first insulation element with a first insulation layer, a second insulation element with a second insulation layer and a third insulation element with a third insulation layer, wherein the second insulation element has a different initial shape than the first (and third) insulation element, wherein the first insulation element is connected to the second insulation element and wherein the second insulation element is deformed when the garment is worn by a pressure on an inner side of the thermal insulation structure in such a way that a contact area, in which the first insulation element contacts the second insulation element, is increased.

The initial shape preferably relates to a shape of the first and second insulation element when no pressure is exerted on the inner side of the thermal insulation structure. Furthermore, the shape preferably relates to a cross-sectional shape of the first and second insulation element. The expression “different initial shape” can further also take into account the orientation of the first and second insulation element. That is, the first and second insulation element can both have the same or a similar (cross-sectional) shape, e.g. both can have an oval shape, but they may be oriented differently. For example, the first insulation element can have an oblate cross-section and the second insulation element can have a prolate cross-section. Such embodiments with a same shape but different orientations of the first and second insulation element are also covered by the expression “different initial shape”.

In some embodiments, the thermal insulation structure has a plurality of first insulation elements and a plurality of second insulation elements, wherein the second insulation elements each have a different initial shape than the first insulation elements, wherein each first insulation element is connected to at least one second insulation element and wherein the second insulation elements are deformed when the garment is worn by a pressure on the inner side of the thermal insulation structure in such a way that contact areas, in which the first insulation elements contact the second insulation elements, are increased.

In some embodiments, the contact area between each first insulation element and the respective second insulation element or the insulation elements to which it is connected is increased when the garment is worn. However, it is also possible that contact areas are increased only between some of the first and second insulation elements.

When the garment according to the invention is worn by a wearer, the first and the second insulation element are arranged one below the other with the first and second insulation layer, while the third insulation element with the third insulation layer is arranged next to the first and the second insulation element.

The thermal insulation structure according to the invention combines the advantages of different initial shapes in the case of the first and second insulation elements with the first and second insulation layer with a third insulation element comprising a third insulation layer. When wearing the clothing, the second insulation elements are deformed in such a way that they initially change their three-dimensional high shape to a flatter shape and thus project beyond any seams and thus at least partially seal any seams or intermediate spaces through which heat could escape. To this end, the third insulation element generates an increase in the thermal resistance by the third insulation element preferably completely but at least partially covering any seam between the first insulation element and the second insulation element.

In some embodiments, at least one first insulation element and at least one second insulation element are connected to a corresponding seam and the increased contact area lies adjacent to the seam, so that the at least one second insulation element substantially overlaps the seam when the garment is worn and the third insulation element additionally covers the seam between the first insulation element and the second insulation element.

In some embodiments, all first and second insulation elements are connected by corresponding seams and there are increased contact areas adjacent to all such seams, so that the second insulation elements substantially overlap all seams and third insulation elements additionally cover the seam between the first insulation elements and the second insulation elements and thus increase the thermal resistance when the garment is worn.

Generally, when in this description in the case of a plurality of first, second and third insulation elements “at least one first insulation element”, “at least one second insulation element”, “at least one third insulation element” is spoken of, this In some embodiments, means all first, second and third insulation elements. However, it is also possible that it means at least one, but not all of the first and/or second and/or third insulation elements.

In order to produce such a thermal insulation structure according to the invention, material layers may be connected to each other such that cavities are formed between the layers. Seams may be used in order to connect the fabric layers, which make up the garment, to each other. A thermal insulation structure may be constructed from two or more discrete insulation elements, which are defined by material layers.

In some embodiments, a garment according to the invention has a first insulation element with a first inner fabric layer and a first outer fabric layer, wherein the first insulation layer is arranged between the first inner fabric layer and the first outer fabric layer, and furthermore the second insulation element comprises a second inner fabric layer and a second outer fabric layer, wherein the second insulation layer is arranged between the second inner fabric layer and the second outer fabric layer, and the third insulation element comprises a third inner fabric layer and a third outer fabric layer, wherein the third insulation layer is arranged between the third inner fabric layer and the third outer fabric layer.

In some embodiments, the first outer fabric layer, the second outer fabric layer and the third inner fabric layer are connected to each other such that the third insulation element constitutes an outermost insulation layer of the thermal insulation structure of the garment according to the invention when the garment is worn.

In some embodiments, at least one first insulation element and/or at least one second insulation element and/or a third insulation element have a filling material. In particular, all first and second insulation elements can have a filling material.

The filling material can considerably enlarge the thermal insulation of the thermal insulation structure. Natural fibers or feathers, in particular down, or synthetic fibers, which, in contrast to down, for example, also have good insulation properties in the moist state, are used in some embodiments as filling material. In the dry state, on the other hand, down have very good thermal insulation properties while at the same time having a low weight. Air, gels, foams, liquids, gases or solids such as granulates are also used in some embodiments as filling material. Evacuated cavities, in order to reduce thermal convection, are also used in some embodiments.

The first insulation layer and/or the second insulation layer and/or the third insulation layer can consist in particular of artificial downs or of a non-woven fabric.

In order to generate a particular degree of insulation of an insulation layer, it is always the stated aim to make a plurality of physical effects technically usable by the use of numerous different insulation materials. A thermodynamic phenomenon, which may be made usable by the use of corresponding technical effort, is heat conduction or thermal diffusion.

As a thermal resistance for inhibiting heat conduction, air is particularly suitable with a thermal conductivity of only

$$0.0262 \frac{W}{mK}$$

compared to common materials in textile technology, such as cotton, polyester or polyamide, which have a thermal conductivity that is higher by a power of ten. Heat energy losses at cold bridges, such as seams or other connecting points, at which no insulation layer is arranged, which in turn encloses air as a thermal resistance, may be reduced with technical solutions, as disclosed in DE102014200824 A1. In order to further increase the insulating capacity for higher-level claims to a heat insulation structure, the two above-mentioned physical effects can in turn be applied again. The increase in the thermal resistance of the garment according to the invention with a thermal insulation structure for overcoming the task of minimizing losses of body heat within the volume, which is delimited from the environment by the third outer layer when the garment is worn, is implemented according to the invention by the first, the second and the third insulation element delimiting a cavity between them and this cavity being filled with a heat-storing medium, wherein the heat-storing medium is preferably air, which, as already stated further above, is known from the prior art as a particularly good insulator and, due to the low thermal conductivity, represents a high thermal resistance, which it is necessary to overcome for the escaping quantity of heat when leaving the volume delimited from the environment by the third outer layer.

In some embodiments, the cavity, which delimits the first, the second and the third insulation element between them, but can also be filled with other heat-storing media, such as down or a non-woven material, which may be, but is not limited to, a meltblown non-woven fabric, a spunlaid non-woven fabric, a staple non-woven fabric or a flashspun non-woven fabric made of polyester or cellulose material.

One possibility of the improved regulation of the stored amount of heat within the volume, which is delimited from the environment by the third outer layer when the garment is worn, is the optional equipping of the respective non-woven materials with phase change materials, in order to support the temperature management by absorbing and storing excess amounts of heat and releasing stored amount of heat, if the prevailing environmental conditions make this necessary, such as e.g. when entering a heated room and/or leaving a heated room into a colder environment relative thereto. In some embodiments, the phase change materials may be dispersed within inclusion structures and protected from abrasion, in order thus to prevent an escape of a phase change material.

As already mentioned, the increase in the thermal resistance takes place in that any seams or intermediate spaces between the first and second elements of the thermal insulation structure are at least partially sealed. Furthermore, the third insulation element, which covers the seams between the first and second insulation elements, can also serve to prevent moisture, for instance fog or rain, from reaching the body of the wearer/user. The keeping away of moisture from the wearer of the garment according to the invention may be supported by the at least waterproof configuration of the third outer fabric layer of the third insulation element. Furthermore, the third outer fabric layer can have additional functionalities, such as, for example, but not limited to, water resistance, water tightness, fire resistance, breathability, wind tightness, tear resistance and elasticity. The additional functionality can preferably be achieved here by the use of membrane materials as the third outer fabric layer.

In some embodiments, the possible seams between the respective first, second and third insulation elements may be configured such that they reduce and/or prevent movements of the insulation layers in the garment, wherein the first, second and/or third insulation layer is divided into several parts, which are arranged in chambers, which are formed by the inner fabric layer and the outer fabric layer of the insulation element. This embodiment of the construction of the thermal insulation structure of the garment according to the invention with the plurality of first, second and third insulation elements furthermore offers an increased mechanical stability compared to a construction with only one first, second and/or third insulation element each.

In a possible embodiment, the chambers of the first and/or second insulation elements run in the horizontal direction and the chambers of the third insulation elements run in the vertical direction when the garment is worn.

The seams between the first, second and third insulation elements of the thermal insulation structure of the garment according to the invention may be configured in a possible embodiment such that the first outer fabric layer of the first insulation element and the second outer fabric layer of the second insulation element and the third inner fabric layer of the third insulation element are connected to each other. The generally used term “seams” is not limited to seams merely in the textile technical sense, but is accessible for the use of other joining methods, such as, for example, different welding methods, such as ultrasonic welding, infrared or friction welding or adhesive bonding methods.

An optional embodiment of the garment according to the invention comprising an inner part, which has the first insulation element and the second insulation element, an outer part, which has the third insulation element, encloses air as thermal resistance between the inner part and the outer part, wherein the inner part and the outer part are connected to each other by connecting elements. Here, air is enclosed in the cavity, which is formed or limited between the first insulation element and the second insulation element of the inner part as well as the third insulation element of the outer part.

The connecting elements, which connect the inner part and the outer part of the garment according to the invention, may be configured to be releasable, e.g., by press studs, zipper or Velcro (e.g. available under the brand name Velcro®)

The connecting elements between the inner part and the outer part of the garment according to the invention may be arranged in a possible embodiment preferably exclusively on the shoulder part and the hip part of the garment.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

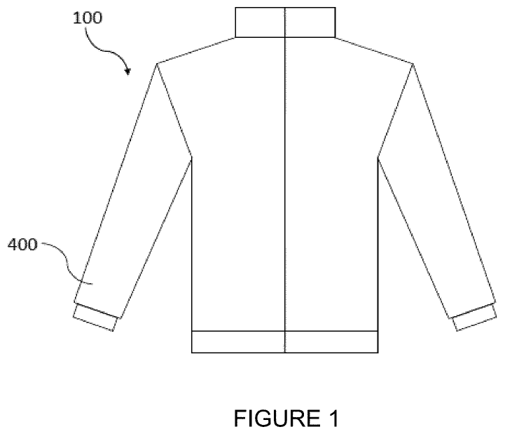

FIG. 1 shows an embodiment of the garment according to the invention as a jacket 100. The embodiment of the jacket 100 can also be designed here as a coat, in that the length of the back and chest part are designed correspondingly longer. A jacket 100 or coat each have a thermal insulation structure 400 according to the invention in the individual components, such as for example in the back and chest part and in the sleeves.

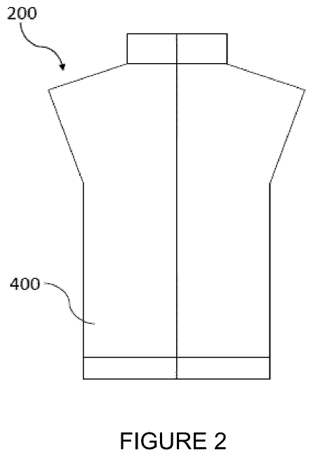

FIG. 2 shows an embodiment of the garment according to the invention as a vest 200. The sleeve length of such an embodiment of the garment according to the invention can vary here as a vest 200, from a sleeve length for example to the elbow of a wearer, when the garment according to the invention is worn as a vest 200 or for example merely to the shoulder of a wearer when the garment according to the invention is worn as a vest 200. A vest 200 in this case has a thermal insulation structure 400 according to the invention in the individual components, such as for example in the back and chest part and in the sleeves—long as present in the embodiment.

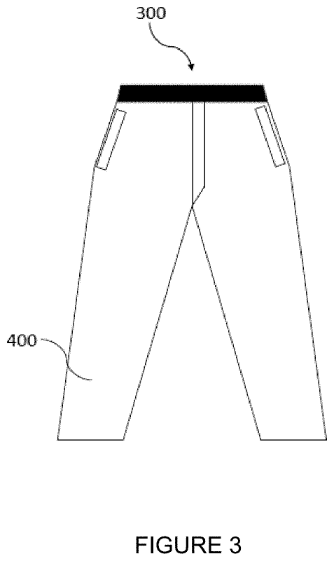

FIG. 3 shows an embodiment of the garment according to the invention as trousers 300. The leg length of such an embodiment of the garment according to the invention can vary here as trousers 300, from a leg length for example to the knee of a wearer, when the garment according to the invention is worn as trousers 300 or for example to the instep of a wearer when the garment according to the invention is worn as trousers 300. A pair of trousers 300 in this case has a thermal insulation structure 400 according to the invention in the individual components, such as for example in the front and rear leg part, in the buttocks and in the crotch.

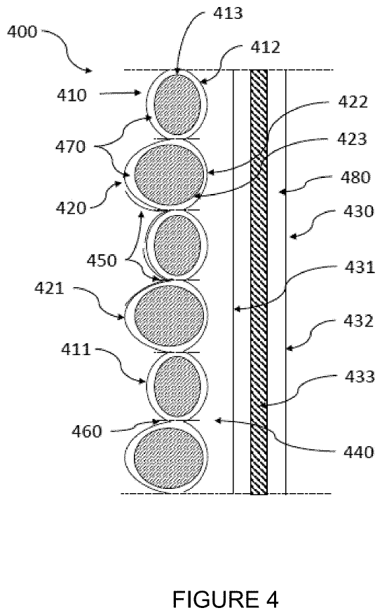

FIG. 4 shows an exemplary embodiment of a thermal insulation structure 400 according to the invention. The thermal insulation structure 400 may be used for example in clothing. The thermal insulation structure 400 has a first insulation element 410 and a second insulation element 420 and a third insulation element 430. The second insulation element 420 has a different initial shape than the first insulation element 410, and the first insulation element 410, the second insulation element 420 and the third insulation element are connected to each other. When a piece of clothing is worn with the thermal insulation structure 400, the third insulation element 430 faces outwards and the second insulation element 420 is deformed by a pressure on an inner side of the thermal insulation structure 400, so that contact surfaces 450, in which the first insulation elements 410 touch the second insulation elements 420, are enlarged and the third insulation element 430 forms in combination with the first insulation element 410 and the second insulation element 420 a cavity 440, in which a first heat storage medium (e.g. air) is enclosed.

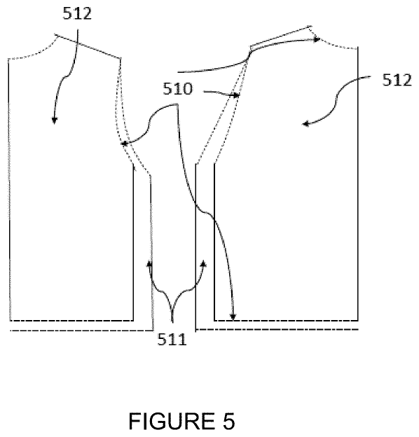

FIG. 5 shows the cocoon structure of the garment 100, 200, 300 according to the invention with the connecting elements 510 between the inner part 511 of the garment 100, 200, 300 according to the invention and the outer part 512 of the garment 100, 200, 300 according to the invention.

In the exemplary embodiment shown in FIG. 4, the thermal insulation structure 400 has a plurality of first insulation elements 410 and a plurality of second insulation elements 420. The second insulation elements 420 each have a different initial shape than the first insulation elements 410. Each first insulation element 410 is connected to at least one second insulation element 420. When a garment with thermal insulation structure 400 is worn, the second insulation elements 420 are deformed by a pressure on the inner side of the thermal insulation structure 400, so that contact areas 450, in which the first insulation elements 410 contact the second insulation elements 420, are increased. In the advantageous case shown here, there are enlarged contact areas 450 between all insulation elements 410, 420 of the thermal insulation structure 400 when pressure is exerted, so that connections 460, e.g. seams 460, are sealed by the enlarged contact areas 450. However, it is also possible that contact areas are increased only between some of the first and second insulation elements 410, 420.

The enlarged contact areas 450, in which the first insulation elements 410 contact the second insulation elements 420, can in particular reduce an escape of body heat when a garment with thermal insulation structure 400 is worn. The third insulation element 430 itself and the resulting cavity 440 between first insulation elements 420, second insulation elements 420 and the third insulation elements 430 increase the thermal resistance of the thermal insulation structure 400. The insulation elements 410, 420, 430 can for example be formed by fabric layers 411, 412, 421, 422, 431, 432, which are connected to seams 460 or connecting elements 510 and form cavities 440 and 470 between these.

The fabric layers 411, 412, 421, 422, 431, 432 may be constructed from a single material or, in some embodiments, from a plurality of materials. Useful materials for the construction of such fabric layers 411, 412, 421, 422, 431, 432 include, but are not limited to, down-solid materials such as micro-lightweights, lightweight fabrics, ultralight fabrics, lightweight wovens, breathable fabrics, polyesters such as woven polyester and brushed polyester, nylon, cloth, cotton, wool, fleece, silk, flannel, closely knitted or woven fabrics or combinations thereof.

Furthermore, the fabric layers 411, 412, 421, 422, 431, 432 may be treated, for example, with a down sealant or chemical agents such as a durable water repellant or the like. Furthermore, the fabric layers 411, 412, 421, 422, 431, 432 can also be designed, for example, to be breathable and/or windproof. To this end, the cavities 470, 480 of the first, second and third insulation elements 410, 420, 430 can each be filled with a first insulation layer 413, a second insulation layer 423 and a third insulation layer 433, which in some embodiments in each case for the first, second and third insulation elements 410, 420, 430 consists of the same material. In further embodiments, the first, second and third insulation layers 413, 423, 433 can also consist of different materials. In some embodiments, the insulation layers 412, 423, 433 can consist of, but in this case are not limited to, air, gels, foams, liquids, gases or solids such as granulates as filling material. In some embodiments, evacuated cavities, in order to reduce thermal convection, are used.

As already mentioned, the first, second and the third insulation element delimit a cavity 440 between them and this cavity is filled with a heat-storing medium, wherein the heat-storing medium is preferably air. In some embodiments, the cavity 440, which delimits the first, the second and the third insulation element between them, but can also be filled with other heat-storing media, such as down or a non-woven material, which may be, but is not limited to, a meltblown non-woven fabric, a spunlaid non-woven fabric, a staple non-woven fabric or a flashspun non-woven fabric made of polyester or cellulose material, which additionally optionally comprises a phase change material, in order to support the temperature management by absorbing and storing excess heat quantities and releasing stored heat quantity.

In some embodiments, the first and second insulation elements 410, 420 are connected to each other by a corresponding seam 460. In some embodiments, the increased contact areas 450, which are generated by the pressure on the inner side of the thermal insulation structure 400 when a garment is worn with the same, lie adjacent to the seams 460, so that the second insulation elements 420 substantially overlap or cover the seams 450 when the garment is worn.

The seams 460 between the first and second insulation elements 410, 420 are preferably covered by the third insulation element 430 in addition to the increased contact areas 450, which are generated by the pressure on the inner side of the thermal insulation structure 400 when a garment is worn with the same, adjacent to the seams 460, so that the second insulation elements 420 substantially overlap or cover the seams 450 when the garment is worn, in order to further reduce a heat loss through the seams 460.

The seams 460 may be, for example, stitching seams. The seams 460 can also be formed by another known construction method, including, but not limited to, chemical bonding, mechanical bonding, thermal bonding, adhesives, bonding tape, fusible threads and/or materials, welding such as, for example, ultrasonic welding, radio frequency welding, etc., stitching with, for example, blanket stitch (Languettenstich), chain stitch, cross stitch, embroidery stitch, garter stitch, back stitch (Steppstich), line stitch (Stickstich), zigzag stitch, stretch stitch, overlock stitch, cover stitch, topstitch, etc., riveting, heat treatment or combinations thereof. Furthermore, the seams or parts of the seams can include a seal which makes it difficult for heat, air, liquid, dirt, etc., to penetrate the seams 460. Furthermore, in some embodiments, other types of connections 460 are used. The respective first and second insulation elements 410 and 420 can, for example, also be connected to each other via beams or connecting regions configured in another manner.

The connecting elements 510 may be, for example, stitching seams. The connecting elements 510 can also be formed by another known construction method, including, but not limited to, chemical bonding, mechanical bonding, thermal bonding, adhesives, bonding tape, fusible threads and/or materials, welding such as, for example, ultrasonic welding, radio frequency welding, etc., stitching with, for example, blanket stitch (Languettenstich), chain stitch, cross stitch, embroidery stitch, garter stitch, back stitch (Steppstich), line stitch (Stickstich), zigzag stitch, stretch stitch, overlock stitch, cover stitch, topstitch, etc., riveting, heat treatment or combinations thereof. Furthermore, the seams or parts of the seams can include a seal which makes it difficult for heat, air, liquid, dirt, etc., to penetrate the seams 510, above all from the outer side. Furthermore, in some embodiments, other types of connections 510 are also used. The respective first and second insulation elements 410 and 420 as inner part 511 and the third insulation elements 430 can, for example, also be connected to each other via beams or connecting regions configured in another manner. In particular, the connecting elements 510 may be designed as a releasable connection, such as, by way of example, as a zipper, as a Velcro fastener or with press studs or as an eyelet, rivet, hole, toggle button.

Shown here are in each case three first and two second insulation elements 410 and 420 and a third insulation element 430, but in some embodiments, in principle, is any number of first and/or second insulation elements 410, 420 greater than two and any number of third insulation elements 430 greater than one. It is also possible that only one first insulation element 410, one second insulation element 420 and one third insulation element 430 is present. For simplification, however, the plural is used in the following description of the embodiment 400. The first insulation elements 410 have a different initial shape than the second insulation elements 420. As shown in FIG. 4, the initial shape of the insulation elements relates to the shape of the insulation elements 410, 420 in an unloaded state, i.e. in a state in which no pressure—example by a wearer of a jacket—exerted on the thermal insulation structure 400.

Furthermore, in each case a first insulation element 410 is connected to a second insulation element 420. In some embodiments, in this case the first insulation elements 410 and the second insulation elements 420 are arranged alternately one below the other and next to the third insulation elements 430, as shown in FIG. 4. In this case, it may be advantageous if all insulation elements 410, 420 are joined alternately to each other and finally as a composite with the third insulation elements 430, e.g., in order to provide a continuous thermal insulation structure 400, as shown here.

The second insulation elements 420 may be deformed during use, so that contact areas 450, in which the first insulation elements 410 contact the second insulation elements 420, are increased by a pressure on an inner side of the thermal insulation structure 400 which is generated during the wearing of the garment. The contact of the first and second insulation elements 410 and 420 can take place directly in this case. However, if the jacket 100 has, for example, a further inner layer (not shown) which is arranged on the inner side of the thermal insulation structure 400, the contact of the first and second insulation elements 410 and 420 can also take place indirectly, for example by a contact of such an inner layer in the respective regions.

As already mentioned, the insulation elements 410, 420 are deformable. A given second insulation element 420 may be deformed during use such that a part of the second insulation element 420 covers an adjacent seam 460 or a part of the seam 230. In particular, the second insulation elements 420 may be configured such that they substantially overlap adjacent seams 460 during use, so that the heat loss at the seams 460 is reduced. If a user wears, for example, a garment with second insulation elements 420, a body or parts of the body of the user can exert a force on the second insulation elements 420, so that these are pressed against the seams 460 and/or the first insulation elements 410. This can lead to the second insulation elements 420 overlapping the adjacent seams 460 with both layers 413, 423 and the filling material.

As already mentioned, the insulation element 430 is arranged next to the insulation elements 410, 420. If the garment 100, 200, 300 according to the invention is worn with a thermal insulation structure, the insulation element 430 overall faces outwards and the inner fabric layer 431 of the insulation element 430 faces inwards. In particular, the third insulation element is arranged such that it covers the seams 460 between the first and second insulation elements 410, 420 during the wearing of the garment 100, 200, 300 according to the invention, which can have the consequence that the adjacent seams 460 are covered by the insulation layer 433 of the third insulation element 430, which increases the thermal resistance and thus reduces the heat loss.

In some embodiments, the possible seams between the third insulation elements 430 may be configured such that they reduce and/or prevent movements of the insulation layer in the garment, wherein the third insulation layer 433 is divided into several parts, which are arranged in chambers, which are formed by the inner fabric layer 431 and the outer fabric layer 432 of the insulation element 430. This embodiment of the construction of the thermal insulation structure 400 of the garment 100, 200, 300 according to the invention with the plurality of third insulation elements 430 furthermore offers an increased mechanical stability compared to a construction with only one third insulation element 430. In some embodiments, the third insulation elements 430 can have special shapes, such as, for example, T-shape, arrow shape, trapezoidal shape, triangular shape, parallelogram shape or rectangular shape.

### EMBODIMENTS

Embodiment 1: Garment (100, 200, 300) with a thermal insulation structure (400), the thermal insulation structure (400) comprising—a first insulation element (410) with a first insulation layer (413); and—a second insulation element (420) with a second insulation layer (423), wherein—the second insulation element (420) has a different initial shape than the first insulation element (410); —the first insulation element (410) is connected to the second insulation element (420), —the second insulation element (420) is deformed when the garment (100, 200, 300) is worn by a pressure on an inner side of the thermal insulation structure (400), so that a contact area (450), in which the first insulation element (410) contacts the second insulation element (420), is increased; characterized in that the thermal insulation structure (400) further comprises a third (430) insulation element with a third insulation layer (433).

Embodiment 2: Garment (100, 200, 300) according to Embodiment 1, wherein—the first insulation element (410) and the second (420) insulation element are arranged one below the other when the garment (100, 200, 300) is worn, and—the third insulation element (430) is arranged next to the first (410) and the second (420) insulation element when the garment (100, 200, 300) is worn.

Embodiment 3: Garment (100, 200, 300) according to Embodiment 2, wherein—the first insulation element (410) and the second insulation element (420) are connected to each other by a seam (460), and—the third insulation element (430) covers the seam (460) between the first insulation element (410) and the second insulation element (420).

Embodiment 4: Garment (100, 200, 300) according to Embodiment 2 or 3, wherein—the first insulation element (410) comprises a first inner fabric layer (411) and a first outer fabric layer (412), wherein the first insulation layer (413) is arranged between the first inner fabric layer (411) and the first outer fabric layer (412), —the second insulation element (420) comprises a second inner fabric layer (421) and a second outer fabric layer (422), wherein the second insulation layer (423) is arranged between the second inner fabric layer (421) and the second outer fabric layer (422), and—the third insulation element (430) comprises a third inner fabric layer (431) and a third outer fabric layer (432), wherein the third insulation layer (433) is arranged between the third inner fabric layer (431) and the third outer fabric layer (432).

Embodiment 5: Garment (100, 200, 300) according to Embodiment 4, wherein the third insulation element (430) constitutes an outermost insulation layer of the thermal insulation structure (400) when the garment (100, 200, 300) is worn.

Embodiment 6: Garment (100, 200, 300) according to Embodiment 1, wherein—the first (410), the second (420) and the third insulation element (430) delimit a cavity (440) between them, —the cavity (440) is filled with a heat-storing medium, and—the heat-storing medium comprises air, down or a non-woven fabric.

Embodiment 7: Garment (100, 200, 300) according to Embodiment 1, wherein the first insulation layer (413) and/or the second insulation layer (423) and/or the third insulation layer (433) consists of real down, artificial down or of a non-woven fabric.

Embodiment 8: Garment (100, 200, 300) according to Embodiment 1, wherein the third insulation layer (433) of the third insulation element (430) is a non-woven material.

Embodiment 9: Garment (100, 200, 300) according to any one of the preceding claims, wherein the third outer fabric layer (432) of the third insulation element (430) is waterproof.

Embodiment 10: Garment (100, 200, 300) according to Embodiment 1, wherein the third insulation layer (433) is divided into several parts, wherein the parts of the insulation layer are arranged in chambers, wherein the chambers are formed by the third inner fabric layer (431) and the third outer fabric layer (432) of the third insulation element (430).

Embodiment 11: Garment (100, 200, 300) according to Embodiment 10, wherein the chambers run in a vertical direction when the garment is worn.

Embodiment 12: Garment (100, 200, 300) according to any one of the preceding Embodiments, wherein the first outer fabric layer (412) of the first insulation element (410) and the second outer fabric layer (422) of the second insulation element (420) and the third inner fabric layer (431) of the third insulation element (430) are connected to each other.

Embodiment 13: Garment according to any one of the preceding Embodiments, wherein the garment is a jacket (100), a vest (200), a coat or a pair of trousers (300).

Embodiment 14: Garment (100, 200, 300) according to any one of Embodiments 6 to 13, wherein—the garment (100, 200, 300) comprises an inner part (511), wherein the inner part (511) has the first insulation element (410) and the second insulation element (420), —the garment (100, 200, 300) comprises an outer part (512), wherein the outer part (512) has the third insulation element (430), —air is enclosed in the cavity (440), which is formed between the first insulation element (410) and the second insulation element (420) of the inner part (511) as well as the third insulation element (430) of the outer part (512), and—the inner part (511) and the outer part (512) are connected to each other by connecting elements (510).

Embodiment 15. Garment according to Embodiment 14, wherein the garment is a jacket (100), a coat (100) or a vest (200), and wherein the connecting elements (510) are arranged exclusively on the shoulder part and on the hip part of the garment (100, 200).

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

1. A garment having a thermal insulation structure, the thermal insulation structure comprising
a first insulation element with a first insulation layer; and
a second insulation element with a second insulation layer, wherein
the second insulation element has a different initial shape than the first insulation element;
the first insulation element is connected to the second insulation element,
the second insulation element is deformed when the garment is worn by a pressure on an inner side of the thermal insulation structure, so that a contact area, in which the first insulation element contacts the second insulation element, is increased; characterized in that the thermal insulation structure further comprises a third insulation element with a third insulation layer.

2. The garment according to claim 1, wherein:
the first insulation element and the second insulation element are arranged one below the other when the garment is worn, and
the third insulation element is arranged next to the first and the second insulation element when the garment is worn.

3. A garment according to claim 2, wherein:
the first insulation element and the second insulation element are connected to each other by a seam, and
the third insulation element covers the seam between the first insulation element and the second insulation element.

4. A garment according to claim 2, wherein
the first insulation element comprises a first inner fabric layer and a first outer fabric layer, wherein the first insulation layer is arranged between the first inner fabric layer and the first outer fabric layer,
the second insulation element comprises a second inner fabric layer and a second outer fabric layer, wherein the second insulation layer is arranged between the second inner fabric layer and the second outer fabric layer, and
the third insulation element comprises a third inner fabric layer and a third outer fabric layer, wherein the third insulation layer is arranged between the third inner fabric layer and the third outer fabric layer.

5. A garment according to claim 4, wherein the third insulation element constitutes an outermost insulation layer of the thermal insulation structure when the garment is worn.

6. A garment according to claim 1, wherein:
the first, the second and the third insulation element delimit a cavity between them,
the cavity is filled with a heat-storing medium, and
the heat-storing medium comprises air, down or a non-woven fabric.

7. A garment according to claim 1, wherein the first insulation layer, the second insulation layer, the third insulation layer, or combinations thereof consist of real down, artificial down or of a non-woven fabric.

8. A garment according to claim 1, wherein the third insulation layer of the third insulation element is a non-woven material.

9. A garment according to claim 1, wherein the third outer fabric layer of the third insulation element is waterproof.

10. A garment according to claim 1, wherein the third insulation layer is divided into several parts, wherein the parts of the insulation layer are arranged in chambers, wherein the chambers are formed by the third inner fabric layer and the third outer fabric layer of the third insulation element.

11. A garment according to claim 10, wherein the chambers run in a vertical direction when the garment is worn.

12. A garment according to claim 1, wherein the first outer fabric layer of the first insulation element and the second outer fabric layer of the second insulation element and the third inner fabric layer of the third insulation element are connected to each other.

13. A garment according to any one of the preceding claims, wherein the garment is a jacket, a vest, a coat or a pair of trousers.

14. A garment according to claim 6, wherein:
the garment comprises an inner part, wherein the inner part has the first insulation element and the second insulation element,
the garment comprises an outer part, wherein the outer part has the third insulation element,
air is enclosed in the cavity, which is formed between the first insulation element and the second insulation element of the inner part as well as the third insulation element of the outer part, and
the inner part and the outer part are connected to each other by connecting elements.

15. A garment according to claim 14, wherein the garment is a jacket, a coat, or a vest, and wherein the connecting elements are arranged exclusively on the shoulder part and on the hip part of the garment.
